(19) United States
(12) Patent Application Publication
(10) Pub. No.: US 2020/0192261 A1
(43) Pub. Date: Jun. 18, 2020

(54) SETTING DETERMINATION APPARATUS, IMAGE FORMING APPARATUS AND IMAGE FORMING OPERATION SETTING METHOD

(71) Applicant: Konica Minolta, Inc., Tokyo (JP)

(72) Inventors: Satoshi OGATA, Tokyo (JP); Yumiko IZUMIYA, Tokyo (JP); Kazutoshi YOSHIMURA, Tokyo (JP)

(21) Appl. No.: 16/718,599

(22) Filed: Dec. 18, 2019

(30) Foreign Application Priority Data
Dec. 18, 2018 (JP) 2018-236491

(51) Int. Cl. G03G 15/00

(52) U.S. Cl. CPC G03G 15/5029; G03G 2215/00071; G03G 15/5062; G03G 15/5025

(57) ABSTRACT

A setting determination apparatus includes: a measurer that measures a physical property of a medium; and a hardware processor. The hardware processor specifies a basis weight and a type of the medium based on a result of the measurement by the measurer and outputs the specified basis weight and type of the medium as a medium setting candidate for an operation setting for image forming.

### CROSS-REFERENCE TO RELATED APPLICATIONS

The present invention claims priority under 35 U.S.C. § 119 to Japanese Patent Application No. 2018-236491 filed on Dec. 18, 2018 the entire contents of which are incorporated herein by reference.

### BACKGROUND

### Technological Field

This invention relates to a setting determination apparatus, an image forming apparatus and an image forming operation setting method.

### Description of the Related Art

Conventionally, there are image forming apparatuses that provide a color material on a medium (recording medium) to form an image. For the color material, e.g., toner and ink have widely been used. Examples of the medium include paper mediums. The paper mediums include those having various physical properties including plain paper and high-quality paper and are appropriately selected and used depending on the usage of an image to be formed.

Where an image is formed on various mediums such as stated above, the formed image is optimized by adjusting various parameters such as an amount of color material according to physical properties of the mediums. JP 2014-81439A discloses a technique that selects a proper medium based on medium brand names registered in advance and an acquired basis weight. Also, JP 2015-176399A discloses a technique that acquires a medium matching characteristics obtained as a result of analysis of a medium as a candidate from products whose characteristics are registered in a database in advance.

### SUMMARY

However, there is a problem in that it takes effort to detect a medium of a correct brand from products of various brands including new products and improved products to make settings for image forming operation.

An object of this invention is to provide a setting determination apparatus, an image forming apparatus and an image forming operation setting method that enable easily making favorable settings for image forming operation.

To achieve at least one of the abovementioned objects, a setting determination apparatus reflecting one aspect of the present invention comprises:

a measurer that measures a physical property of a medium; and

a hardware processor,

and the hardware processor specifies a basis weight and a type of the medium based on a result of the measurement by the measurer and outputs the specified basis weight and type of the medium as a medium setting candidate for an operation setting for image forming.

To achieve at least one of the abovementioned objects, an image forming operation setting method for a setting determination apparatus including a measurer that measures a physical property of a medium, reflecting one aspect of the present invention comprises:

specifying a basis weight and a type of the medium based on a result of the measurement by the measurer; and

outputting the specified basis weight and type of the medium as a medium setting candidate for an operation setting for image forming.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 is a schematic diagram illustrating an overall configuration of an image forming apparatus according to an embodiment of the present invention;

FIG. 2 is a block diagram illustrating a functional configuration of the image forming apparatus;

FIG. 3 is a diagram for describing a control parameter setting method in the image forming apparatus;

FIG. 4A is a diagram illustrating an example of a medium selection screen displayed on a display;

FIG. 4B is a diagram illustrating an example of the medium selection screen displayed on the display;

FIG. 5 is a flowchart illustrating a control procedure for medium setting processing;

FIG. 6A is a diagram illustrating another example of a medium selection screen displayed on the display;

FIG. 6B is a display illustrating another example of the medium selection screen displayed on the display; and

FIG. 7 is a flowchart illustrating a control procedure for medium selection processing according to the selection screen in the alteration illustrated in FIG. 6.

### DETAILED DESCRIPTION OF THE EMBODIMENTS

An embodiment of the present invention will be described below with reference to the drawings. However, the scope of the invention is not limited to the disclosed embodiments.

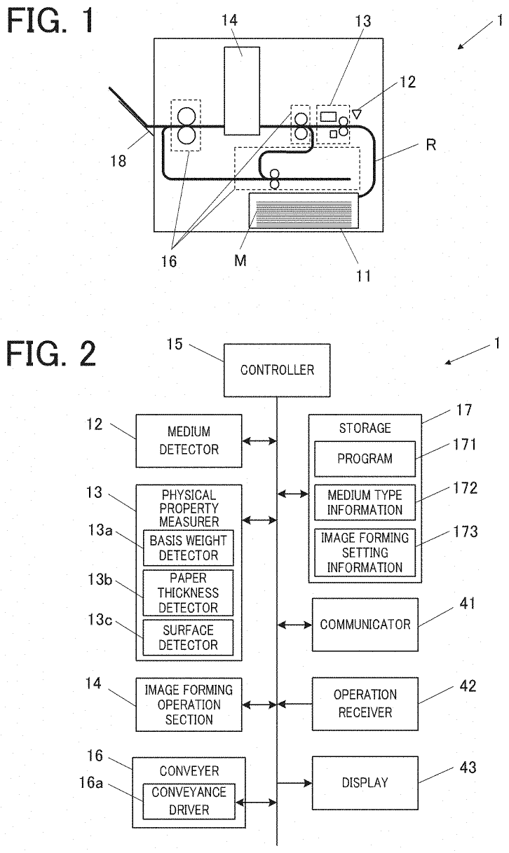

FIG. 1 is a schematic diagram illustrating an overall configuration of an image forming apparatus 1 (which also operates as a setting determination apparatus) according to the present embodiment.

The image forming apparatus 1 is intended to provide a color material on a medium M to form an image, and for example, an image forming apparatus that causes toner to adhere and be fixed to a medium M by means of electrophotography. The image forming apparatus 1 includes, e.g., a medium supplier 11, a medium detector 12, a physical property measurer 13 (measurer), an image forming operation section 14, a controller 15 (see FIG. 2), a conveyer 16 and an output tray 18.

The medium supplier 11 includes, e.g., a tray, holds mediums M (recording mediums), which are objects to be subjected to image forming, and feeds a medium M to a conveyance route R at a proper timing under the control of the controller 15. It is possible that: a plurality of trays are provided; and a medium M is supplied selectively from a tray designated by operation settings. The conveyer 16 moves the medium M along the conveyance route R at a set speed. The conveyer 16 includes, e.g., rollers that pinch and advance the medium M and rotation motors that rotate the rollers. Also, the conveyer 16 includes a reverser that reverses front and back sides of the medium M with an image formed on one of the sides from each other to form an image again.

The medium detector 12 detects the medium M that is moving on the conveyance route R by means of the conveyer 16, at a predetermined position, here, at a position a predetermined distance short of a position of image forming by the image forming operation section 14. For the medium detector 12, for example, an optical sensor (e.g., a photodiode) that detects presence of a medium M according to interruption of light by the medium M or detects reaching of a medium M to the predetermined position according to changes in detected intensity of reflected light depending on whether or not the medium M is present is used. Based on a timing of detection of a leading edge of the medium M by the medium detector 12 and a speed of conveyance by the conveyer 16, a timing for image forming by the image forming operation section 14 is controlled to form an image at a proper position on the medium M.

The physical property measurer 13 measures physical quantities according to physical properties of the medium M. The physical properties that can be measured of a measurement object include at least basis weight.

A measurement operation by the physical property measurer 13 is, for example, performed at a plurality of positions in the medium M while movement of the medium M being temporarily halted at intervals of a predetermined distance, and a result of arithmetic processing such as an average of a plurality of values obtained is finally used as a physical property value.

The physical property measurer 13 is not limited to one incorporated in the image forming apparatus 1 and may be one that can be installed and operate externally as necessary. In this case, the image forming apparatus 1 may be provided with a connector for a wiring for power supply to and signal transmission/reception to/from the physical property measurer 13.

The image forming operation section 14 includes an image forming engine (print engine) that causes a color material such as toner or ink to adhere and be fixed to the medium M to form an image on the medium M. The image forming operation section 14 is not specifically limited, and for example, forms (develops) respective toner images of four colors, C, M, Y and K, and the like, on a photoconductor by means of electrophotography and transfers the toner images onto the medium M, here, via a transfer member to form a color image.

The medium M fed from the medium supplier 11 and moved through the conveyance route R is output to the output tray 18. Also, before the output tray 18, various post-processing apparatuses and the like that perform various types of post-processing such as drying, cutting and/or sorting may be connected.

FIG. 2 is a block diagram illustrating a functional configuration of the image forming apparatus 1 according to the present embodiment.

The image forming apparatus 1 includes, e.g., the controller 15 (hardware processor), a conveyance driver 16a, a storage 17, a communicator 41, an operation receiver 42 and a display 43 in addition to the medium detector 12, the physical property measurer 13 and the image forming operation section 14 described above.

The physical property measurer 13, here, includes a basis weight detector 13a, a paper thickness detector 13b and a surface detector 13c, and detects paper thickness and surface smoothness in addition to basis weight. The paper thickness detector 13b performs measurement, for example, via a displacement roller for detecting a center distance between two roller that are movable in a direction of a thickness of a medium M according to the thickness. Also, the surface detector 13c uses, for example, a reflection sensor that outputs intensities of normal reflected light and scatter-reflected light of applied light (for example, a mixture of infrared light and visible light having a predetermined wavelength) and/or an intensity ratio between the intensities to obtain a surface smoothness based on the intensity ratio.

The basis weight detector 13a is not specifically limited and may be capable of measuring, for example, some or all of physical property values such as density, air permeability, frictional coefficient, whiteness, stiffness and/or electric resistance. Also, for detection of basis weight, a result from a weight sensor that directly measures weight of a medium may be used. For air permeability, e.g., an air suction speed where air is sucked with predetermined pressure from one surface may be used. Also, electric resistance is obtained based on a magnitude of electric current flowing when a predetermined voltage is applied between front and back sides of a medium and a paper thickness of the medium. The basis weight detector 13a, the paper thickness detector 13b and the surface detector 13c are those classified functionally, and physical quantities measured by the basis weight detector 13a, the paper thickness detector 13b and the surface detector 13c may partially overlap one another, and in such case, a result of measurement by a same measurer may be shared. As stated above, in the physical property measurer 13, at least two or three kinds of physical quantities may be measured.

The controller 15 performs centralized control of various operations in the image forming apparatus 1. The controller 15 includes, e.g., a CPU (central processing unit) and a RAM (random access memory). The controller 15 performs control of, e.g., an image forming operation by the image forming operation section 14 and calibration and settings for the image forming operation, by reading a control program stored in the storage 17 to execute the control program by the CPU. Also, as described later, the controller 15 performs recording/setting processing to extract and specify a candidate of a type of a medium M, which is an object to be subjected to image forming, and makes settings for image forming operation, based on a result of the specification.

The conveyance driver 16a outputs drive signals for causing rotation of the motors of the conveyer 16 and causing a supply operation of the medium supplier 11 under the control of the controller 15 to perform adjustment on, e.g., whether or not an operation of conveyance of a medium M is performed and a speed of the conveyance.

The storage 17 stores, e.g., a program 171 to be executed by the controller 15, setting data to be used in the program and image data for an image of the object to be formed by the image forming operation section 14. For the storage 17, for example, a non-volatile storage medium such as an HDD (hard disk drive) or a flash memory is used. Also, the storage 17 may include a RAM and the RAM may be used for temporarily storing some of data or processing some of data.

In the storage 17, medium type information 172 and image forming setting information 173 are stored as setting data.

The medium type information 172 includes a list in which medium types that can be objects to be subjected to image forming and characteristic information pieces of the mediums are associated with each other in advance. Examples of the medium types that are objects include, e.g., plain paper, high-quality paper, gloss paper, matte paper and calendered paper. These types of paper may more simply be categorized into ranges that are largely different in control parameter from each other, such as coated paper including gloss paper and matte paper and non-coated paper including plain paper and high-quality paper. The associated characteristic information pieces are some or all of the respective parameters to be measured by the physical property measurer 13.

Also, mediums stored in the medium type information 172 may include, e.g., various resin films, stone paper and mediums each formed by a plurality types of materials being stacked. These types of mediums have characteristics that are different from those of normal paper mediums. These types of mediums are set as exceptional setting mediums (special mediums) in advance, and corresponding ranges of characteristics (physical property values) are set in association with the respective types of mediums.

In the image forming setting information 173, a plurality of combinations of the aforementioned medium types and basis weights are set and each of the combinations is held in association with operation setting data (control parameters) for image forming. Examples of the operation setting data can include, e.g., a driving voltage (or an amount of deviation from a reference driving voltage) and a fixing temperature (or an amount of deviation from a reference fixing temperature). The basis weight in each of the combinations is here indicated by ranges divided on a predetermined width basis but may be a representative value. The image forming operation section 14 performs an image forming operation based on control parameters acquired according to a selected and set medium type-basis weight combination. Also, the operation setting data for image forming (control parameters) may include not only operation setting parameters for operation of the image forming operation section 14 but also operation setting parameters for operation of the medium supplier 11 and operation of the post-processing apparatuses. Various operation settings such as a degree and/or a limit of pressing in various types of processing such as feeding, sorting, bending, cutting and stapling of a medium M may be set according to, e.g., a thickness, a hardness and/or a surface smoothness of the medium M.

The communicator 41 controls communication with an external communication device based on a predetermined communication standard. For the communication standard, for example, TCP/IP (Transmission Control Protocol/Internet Protocol) communication according to an LAN (local area network) is used, and the communicator 41 includes, e.g., a network card for control of communication via an LAN.

The operation receiver 42 receives an external input operation by, e.g., a user and outputs the content of the received input operation to the controller 15 in the form of an input signal. The operation receiver 42 includes, for example, a touch panel provided so as to overlap a display screen of the display 43 and press button switches. The input signal includes information on an operation of pressing a press button switch, an action of contact with the touch panel and a position of the contact.

The display 43 causes the display screen to provide display under the control of the controller 15. The content of the display includes, e.g., a status relating to an image forming operation and a setting menu for receiving an input operation by the user. The display screen is not specifically limited, but examples of the display screen include, e.g., a liquid-crystal display (LCD) and an organic EL (electro luminescent) display. Also, the display 43 may include, e.g., LED lamps to provide notification of a power supply state and an error state.

The setting determination apparatus according to the present embodiment is formed by the physical property measurer 13 and the controller 15 from among the aforementioned components. Also, the setting determination apparatus may include the storage 17, the operation receiver 42 and the display 43.

Next, a setting operation for image forming in the image forming apparatus 1 according to the present embodiment will be described.

Where an image is formed in the image forming apparatus 1, e.g., a degree of permeation of a color material into a medium, a degree of fixing of the color material to the medium and a degree of spreading (bleeding) of the color material in the medium differ depending on the type of medium to be subjected to the image forming and the characteristics of medium. Consequently, if images are formed with same operation settings, the image qualities of the formed images may be different from one another or may be deteriorated. Therefore, even if images are formed based on same image data, it is necessary to change various conditions such as a proper amount of color material to be provided and a proper temperature for fixing of the color material. In order to form an optimum image based on image data, in the image forming apparatus 1, control parameters for image processing and image forming operation are changed to favorable values for a type and characteristics of a medium M.

Although there are various physical property values indicating characteristics such as described above, here, at least basis weight is used as a representative parameter affecting image forming. For example, the magnitude of basis weight largely affects electric resistance during transfer and a thermal capacity during fixing operation. Here, sections of basis weight, which are divided on a predetermined width basis, are set. As described above, for example, a section in which the basis weight obtained based on results of measurement by the physical property measurer 13 is fallen or a section neighboring the section may be selected.

In the image forming apparatus 1, in consideration of parameters affecting, e.g., permeability and/or spreadability of a color material according to a type of the medium, that is, various characteristics such as surface finishing, a material and a thickness of the medium in addition to the above parameters, control parameters that enable obtainment of a formed image of sufficient image quality may be set for many of mediums currently mainly used for image forming (mainly paper mediums in the present embodiment in which the image forming operation section 14 that forms an image by means of electrophotography is used). For medium types, those set in the above-described medium type information 172 are used and at least paper mediums are categorized into coated paper and non-coated paper. Whether coated or non-coated largely affects characteristics of, e.g., fixing of a color material. Note that it is less likely that a medium fails to be classified into coated paper or non-coated paper based on results of measurement by the physical property measurer 13 and both of coated paper and non-coated paper are output as candidates for the medium, but in this case, coated paper setting candidates are preferentially output in consideration of, e.g., a degree of image quality deterioration where a setting that is different from a proper setting is made.

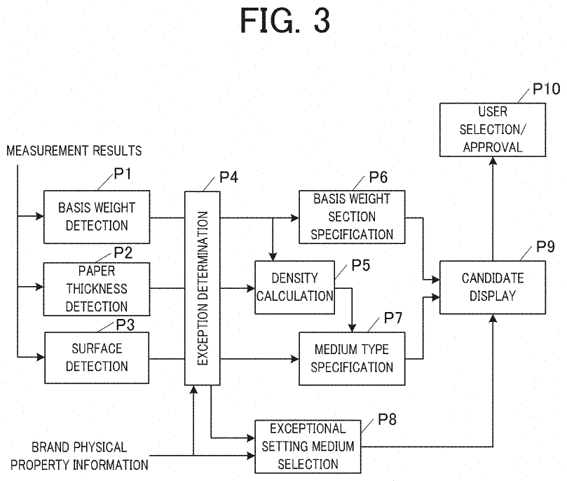

FIG. 3 is a diagram for describing a control parameter setting method in the image forming apparatus 1 according to the present embodiment. In the image forming apparatus 1, results of measurement by the physical property measurer 13 are acquired. A basis weight is obtained based on a result of measurement by the basis weight detector 13a (P1), a paper thickness is obtained based on a result of measurement by the paper thickness detector 13b (P2) and a smoothness is obtained based on a result of measurement by the surface detector 13c (P3).

Based on these parameters, first, whether or not conditions for a combination of respective values determined in advance in the aforementioned ranges of characteristics of an exceptional setting medium (predetermined conditions) are satisfied is determined (P4). If the conditions for an exceptional setting medium are satisfied, the exceptional setting medium is specified as a setting candidate based on brand physical property information held in the medium type information 172 (P8) and sent (output) to candidate display (P9). A destination of the sending is here the display 43. In other words, in the case of an exceptional setting medium, the subsequent specification and display of normal setting candidates are automatically cancelled.

If the conditions for an exceptional setting medium are not satisfied, a basis weight section whose degree of matching with the obtained basis weight meets a predetermined criterion, is specified (P6). The degree of matching may simply be a numerical value determined based on a difference from a reference value or may be a value that varies depending on, e.g., a combination (balance) of the respective measurement values used for obtainment of the basis weight. Also, a density is calculated based on the basis weight and the paper thickness (P5) and based on the density and the smoothness, a medium type section whose degree of matching meets the predetermined criterion from among the medium type sections set in advance, is determined (P7). A matching degree of a medium type section may also be quantified based on, e.g., a deviation from reference values for respective measurement values used for specification of the medium type and a balance of the measurement values. A combination of the basis weight section and the medium type section meeting the criterion (specified) is sent (output) to candidate display (P9) as a medium setting candidate for operation settings for image forming, and the setting candidate is displayed on the display screen of the display 43. The number of setting candidates is not limited to one and for example, both setting candidates, that is, a plurality of setting candidates may be selected in the case of, e.g., the basis weight falling around a boundary of sections.

In the candidate display, candidates are output in descending order of a value of comprehensive evaluation of the obtained two matching degrees, for example, a value of addition of the two degrees (that is, a descending order of matching degree), as higher priority candidates, and here, are displayed on the display 43. Only one candidate may be output, or if there are a plurality of candidates whose respective matching degrees meet the criterion, the plurality of candidates may be output. Final selection and approval are made by the user, here, via an operation of input to the operation receiver 42 (P10), and operation settings relating to the setting candidate according to a result of the selection are made. Here, selection of any of the setting candidates leads to obtaining image quality meeting a predetermined criterion. Therefore, the user may simply select a highest priority one or also may select one based on, e.g., the user's preference or a part of information on the medium, the part being held by the user. It is possible that operation settings once selected are provided with a proper name and stored in the storage 17, and thus can be called up and used in the future.

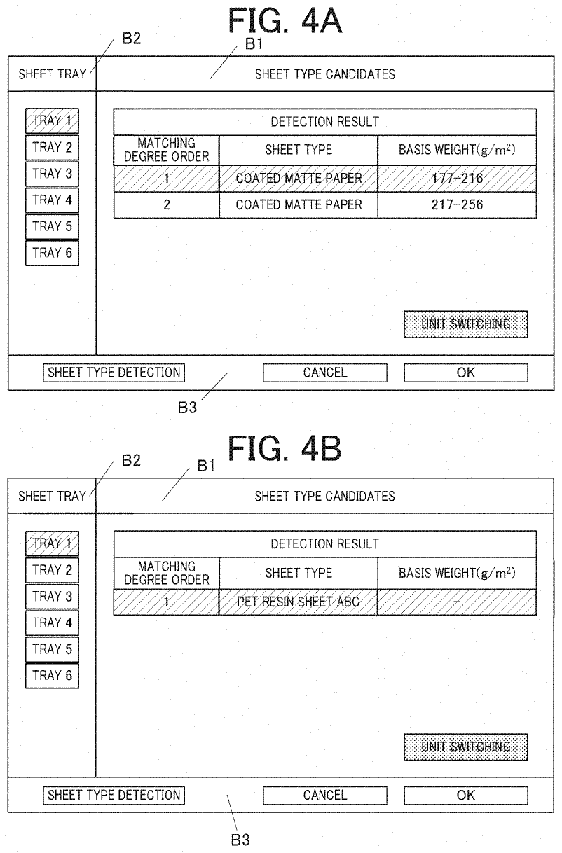

FIG. 4A and FIG. 4B are diagrams each illustrating an example of a medium selection screen displayed on the display 43. Here, example display where a paper medium (sheet) is normally selected as a medium is illustrated.

As illustrated in FIG. 4A, upon an operation of selecting (e.g., clicking or touching) a sheet type detection button on an operation selection button display screen B3 being performed, the physical property measurer 13 performs physical property measurement of a medium set in advance, and candidates specified according to results of the physical property measurement are displayed on a sheet type candidate display screen B1. Here, two candidates are specified and a sheet type and a basis weight section of each candidate are displayed so as to be selectable, in descending order of the degree of matching. Here, the basis weight sections are displayed in unit of [g/m²], but the unit can be switched to another unit by selection via a unit switching button. Upon an operation of selecting any of the rows of the candidates being received, the selected row (here, the upper row) is highlighted.

A sheet tray selection screen B2 on the left side determines a tray that stores mediums to be subjected to image forming operation settings according to the selected sheet. Here, tray 1 is selected via a selection operation and thereby highlighted.

An operation of selecting an “OK” button on the operation selection button display screen B3 being performed, the selected sheet type and the tray to which the image forming settings according to the sheet type are applied are determined.

Also, as described above, if measurement results corresponding to those set in advance for an exceptional setting medium, which are largely different from those of sheet settings used in many cases, are obtained, a sheet type according to the measurement results is directly displayed as a sheet type candidate. Here, as illustrated in FIG. 4B, a particular PET resin sheet is displayed as a sole candidate.

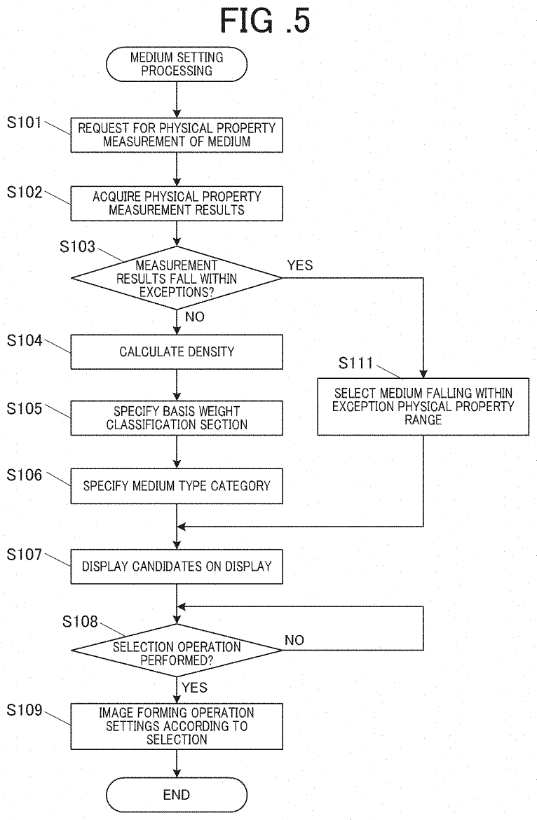

FIG. 5 is a flowchart illustrating a procedure of control by the controller 15 for medium setting processing.

Upon a start of medium setting processing, the controller 15 requests the physical property measurer 13 to perform physical property measurement of a set medium (step S101). The controller 15 acquires results of the physical property measurement from the physical property measurer 13 (step S102).

The controller 15 refers to exceptional settings stored in the storage 17 and determines whether or not the measurement results fall within respective physical property ranges for exceptional setting mediums set in advance (step S103). If it is determined that the measurement results fall within the physical property ranges for any of exceptional setting mediums (“YES” in step S103), the controller 15 selects the relevant exceptional setting medium (step S111). Then, the processing in the controller 15 transitions to step S107.

If it is determined that the measurement results fall within none of the physical property ranges for the exceptional setting mediums (“NO” in step S103), the controller 15 calculates a density from the obtained physical property measurement values (step S104). The controller 15 specifies a basis weight classification section from among those set for the respective image forming operation settings (step S105). The controller 15 specifies a paper type category from among those set for the respective image forming operation settings (step S106). Then, the processing in the controller 15 transitions to step S107. The processing in steps S101 to step S106 corresponds to a specification step in an image forming operation setting method according to the present embodiment.

Upon transition to processing in step S107, the controller 15 causes setting candidates according to any of the image forming operation settings to be displayed (step S107: candidate output step). If the processing in steps S105 and S106 has been performed, the controller 15 causes the specified basis weight section and the specified paper type category to be displayed. Since the operation settings for basis weight have tolerance, a plurality of basis weight sections may be selected. Also, some of the physical property measurement values corresponding to a paper type category may overlap those of another paper type category, and thus, a plurality of paper type categories may be selected. If the processing in step S111 has been performed, the controller 15 causes the selected medium type to be directly displayed as a candidate.

The controller 15 determines whether or not a selection operation has been performed (step S108). The controller 15 determines whether or not an operation of selecting any of the rows on the sheet type candidate display screen B1 has been performed, whether or not an operation of selecting a tray to which image forming settings are applied on the sheet tray selection screen B2 has been performed, and whether or not an operation of selecting the “OK” button on the operation selection button display screen B3 has subsequently been performed. If it is determined that at least any of these operations has not been performed (“NO” in step S108), the controller 15 repeats the processing in step S108.

If it is determined that all of the operations described above have been performed (“YES” in step S108), the controller 15 makes image forming operation settings corresponding to the row selected on the sheet type candidate display screen B1, for the tray selected on the sheet tray selection screen B2 (step S109). Then, the controller 15 ends the medium setting processing.

### [Alteration]

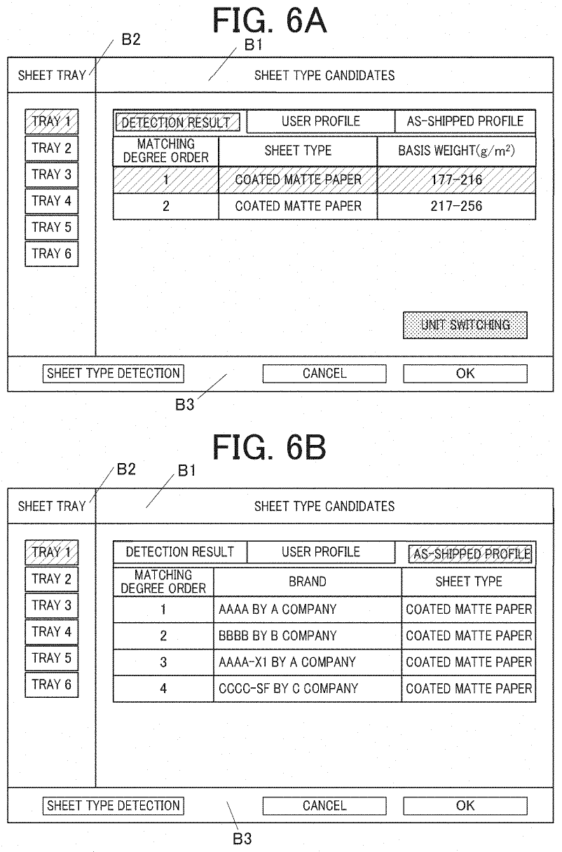

FIG. 6A and FIG. 6B are diagrams illustrating another example of a medium selection screen displayed on the display 43.

Here, as illustrated in FIG. 6A, in addition to display of sheet type candidates according to basis weight section-medium type combinations specified as described above, the display 43 enables switching to directly displaying (enables outputting) specific brands of mediums corresponding to the specified basis weight section-medium type combinations in response to an instruction (request) provided via an operation of selecting a “user profile” tab or an “as-shipped profile” tab.

For example, upon an operation of selecting the as-shipped profile being performed, as illustrated in FIG. 6B, from among medium brands registered in advance in the medium type information 172 in the storage 17 as shipped, brands corresponding to the specified basis weight section-medium type (sheet type) combinations are selected and relevant brand names are displayed in the respective rows. As with the order of display of the combinations described above, the order of display may be a descending order of the degree of matching with the basis weight and the medium type. The display order may be able to be changed based on other items such as brand names and/or sheet types.

In this case, in the medium type information 172 in the storage 17, various brand names and medium characteristics (medium types and basis weights) of the brands are further stored and held in association with each other. This association here includes the “as-shipped profile” set in advance as shipped and the “user profile” manually registered and stored by, e.g., the user after start of use of the image forming apparatus 1. The “as-shipped profile ” and the “user profile” correspond to the respective tabs mentioned above.

If the user knows brands, the number of brands narrowed down based on the basis weight and the sheet type, which includes a setting object brand, becomes sufficiently small, the user can easily and quickly find and set a desired brand. Also, for example, if the user does not know a specific brand but only know a manufacturer or if the user wishes to make settings according to a brand the user knows, the user can easily select a proper brand according to the user's preference because brands enabling obtainment of image quality that is equal to or exceeds a criterion are already selected and displayed.

If an operation of selecting a “detection result” tab is performed in a state in which brands are displayed as a result of selection of the “user profile” tab or the “as-shipped profile” tab, the display is switched back to the original specified basis weight-medium type combinations, in response to an instruction (request) relating to the selection operation.

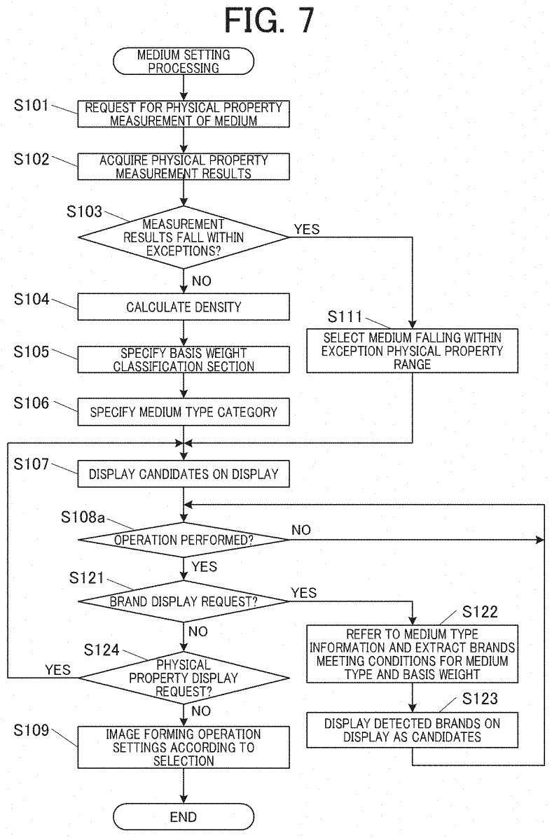

FIG. 7 is a flowchart illustrating a procedure for control by controller 15 for medium selection processing according to the selection screen in the alteration illustrated in FIG. 6A and FIG. 6B.

The medium selection processing is the medium selection processing illustrated in FIG. 5 with the processing in step S108 replaced by processing in step S108a and processing in steps S121 and S124 added. The rest of the processing is the same as the medium selection processing illustrated in FIG. 5 and a processing content that is the same as that of the medium selection processing illustrated in FIG. 5 is provided with a reference numeral that is the same as that of the medium selection processing illustrated in FIG. 5 and detailed description thereof will be omitted.

After display of setting candidates on the display 43 in processing in step S107, the controller 15 determines whether or not an input operation has been performed (step S108a). If it is determined that no input operation has been performed (“NO” in step S108a), the controller 15 repeats the processing in step S108a.

If it is determined that an input operation has been performed (“YES” in step S108a), the controller 15 determines whether or not the content of the operation is a request for display of brands (step S121). If it is determined that the content of the operation is a request for display of brands (“YES” in step S121), the controller 15 refers to the medium type information 172 in the storage 17 and detects brand names falling within a specified paper type category and a specified basis weight section (step S122). The controller 15 causes the detected brand names to be displayed as setting candidates on the display 43 (sheet type candidate display screen B1) (step S123). Then, the processing in the controller 15 returns to step S108a.

If it is determined that the content of the operation is not a request for display of brands (“NO” in step S121), the controller 15 determines whether or not the content of the operation is a request for display of physical properties (step S124). If it is determined that the content of the operation is a request for display of physical properties, that is, a request for return from display of brand names to display of basis weight sections and paper type categories (“YES” in step S124), the processing in the controller 15 returns to step S107.

If it is determined that the content of the operation is not a request for display of physical properties (“NO” in step S124), here, it is determined the content of the operation is an operation of selecting a medium and the processing in the controller 15 transitions to step S109.

As described above, the image forming apparatus 1 (setting determination apparatus) according to the present embodiment includes the physical property measurer 13 that measures physical properties of a medium M and the controller 15. The controller 15 specifies combinations of basis weights and types of medium M based on results of measurement by the physical property measurer 13 and the combinations are output as medium setting candidates for image forming operation settings.

As described above, enabling making image forming operation settings according to a combination of basis weight and a medium type enables easily making operation settings that enables obtainment of normally required image quality without acquisition of many characteristics and strict evaluation. Also, the user can easily acquire characteristics corresponding to an unknown brand and obtain an image of necessary image quality by causing the image forming apparatus to make proper operation settings. Also, since settings are made without forming of a test image, the need for the trouble and technique of, e.g., test image forming and determination of a result of the test image forming is eliminated, enabling more easily and quickly starting normal image forming of an image with proper image quality. Consequently, consumption of color materials such as ink or toner and mediums can be reduced. Also, there is no need to, each time a medium of a new brand is brought to market, make specific settings for the brand, which saves effort.

Also, the controller 15 provides at least categories of coated paper and non-coated paper for classification of the type of the medium M. Since these types of mediums are largely different from each other in, e.g., fixing of a color material and color reproduction, minimum classification of these types of mediums into different categories prevents largely lowering of image quality even with the simple categorization.

Also, the controller 15 calculates degrees of matching between results of measurement by the physical property measurer 13 and basis weights and medium types according to different operation settings and outputs basis weight-medium type combinations whose respective calculated matching degrees meet a predetermined criterion, as setting candidates.

In other words, the degree of proper combination is quantitatively evaluated by numerical processing based on characteristic measurement results, and thus, an optimum candidate can easily be selected. In addition, the user needs no expertise for, e.g., selecting operation settings and thus can cause operation settings enabling proper image forming to be performed, without the need for effort, knowledge and experience.

Also, the controller 15 causes the combinations as setting candidates to be output and displayed in descending order of the degree of matching between the characteristics and medium type of the setting candidate and the characteristics and the medium type obtained based on measurement results. Therefore, unless the user specifically has other knowledge and has operation settings the user actively wishes to select, the user can easily select a setting candidate with a highest degree of matching. Therefore, even without special knowledge, proper operation settings can quickly be made for various types of mediums, with simple processing and small effort.

Also, where both of coated paper and non-coated paper are output as setting candidates, the controller 15 outputs these types of paper in an order with the coated paper prioritized. If distinguishing between coated paper and non-coated paper based on characteristic measurement is difficult, setting candidates are output and displayed in such a manner that coated paper is preferentially set and thus image quality is more stably maintained without being lowered. Also, if stapling processing is performed in post-processing, a staple less easily penetrates through coated paper than non-coated paper and an upper limit of the number of sheets of coated paper through which a stable can penetrate is small. Making settings with coated paper prioritized reduce failures in post-processing, that is, the present image forming apparatus 1 enables making settings favorable not only for image forming operation but also for post-processing operation.

Also, the physical property measurer 13 measures at least two of a surface smoothness, a density, an air permeability, a frictional coefficient, a whiteness, a stiffness and an electric resistance of a medium M. Although various measurement methods may be used for acquisition of a basis weight and determination of a medium type, combination of two or more methods from among these representative methods enables easily and precisely obtaining basis weight-medium type combination candidates without using a special configuration. Therefore, the user can easily select operation settings that are optimum or close to optimum to cause the image forming apparatus 1 to perform image forming operation with good image quality.

Also, the image forming apparatus 1 (setting determination apparatus) includes the display 43. The controller 15 outputs setting candidates to the display 43 and causes the display 43 to display the setting candidates. In other words, a list of setting candidates is displayed directly by the image forming apparatus 1, enabling the user to easily obtain and determine proper operation settings on the spot.

Also, the image forming apparatus 1 (setting determination apparatus) includes the operation receiver 42. The controller 15 accepts an input operation of selecting any of setting candidates displayed on the display 43, via the operation receiver 42 and makes operation settings relating to the selected setting candidate. As described above, operation settings for image forming operation in the image forming apparatus 1 can easily and properly be made by the image forming apparatus 1 itself, and thus, the user can simply select proper operation settings without taking, e.g., data transmission/reception into consideration and cause an image with proper image quality according to the operation settings to be formed.

Also, if results of measurement by the physical property measurer 13 meet predetermined conditions, the controller 15 outputs a specific medium corresponding to the conditions as a setting candidate. In other words, where a medium having characteristics that are largely different from those of normally-used mediums (mainly paper mediums) is used, setting candidates for operation settings is not indicated by medium type-basis weight section combinations in such a manner as described above, but the specific medium can directly be output.

Also, the image forming apparatus 1 (setting determination apparatus) includes the storage 17 (medium type information 172) that stores brand names of mediums and information on basis weight and a type of the medium of each of the brand names in association with each other. The controller 15 can output brand names corresponding to the specified medium type-basis weight combinations as setting candidates for image forming operation settings.

In other words, in the image forming apparatus 1, change to display of brand names can be made after narrowing setting candidates down based on the medium type and the basis weight to a range in which necessary image quality can be obtained. Consequently, for example, if the user knows a brand or if the user knows a manufacturer (supplier) of a medium, the user can easily select proper operation settings. Also, even if the user does not know a medium, necessary image quality can be obtained simply with operation settings for a manufacturer the user is familiar with, enabling proper operation settings to be easily made according to the user's preference.

Also, the controller 15 calculates degrees of matching between a basis weight and a medium type specified based on results of measurement by the physical property measurer 13 and basis weight-medium type combinations of the medium of the brand names determined as setting candidates and output relevant brand names in descending order of the degree. In other words, as in the case of output of setting candidates that are basis weight-medium type combinations described above, in the case of output of brand names, also, the brand names are output as setting candidates in objective descending order of the degree of matching, and thus, for example, where it is difficult to determine which of a plurality of brands is correct with knowledge held in advance, such as a case where the user knows a manufacturer only, it is possible to easily select and set a brand according to the degree of priority. Also, even where a medium of a brand the user knows is used, the brand normally appears around the top, enabling easily finding the brand and making operation settings for the brand.

Also, the controller 15 switches display of setting candidates between display of combinations and display of brand names in response to a request received from the operation receiver 42. In other words, the combination display and the brand name display can be switched from one to the other in response to the user's request, and thus, it is possible to perform switching to display that is more favorable for a medium to be subjected to image forming, more easily and properly select the medium and make operation settings for the medium.

Also, the image forming apparatus 1 according to the present embodiment includes the above-described configuration that serves as the setting determination apparatus, and the image forming operation section 14 that forms an image on a medium. Therefore, the image forming apparatus 1 enables easily making operation settings enabling obtainment of proper image quality, according to a basis weight and a medium type obtained based on measurement results, to form an image.

Also, the image forming operation setting method according to the present embodiment includes a specification step of specifying a combination of a basis weight and a medium type based on results of measurement by the physical property measurer 13 (corresponding to steps S101 to S106) and a candidate output step of outputting the specified combination as a medium setting candidate for an image forming operation setting (corresponding to step S107). The image forming operation setting method enables easily making operation settings enabling sufficient image quality with fewer characteristics. Since there is no need to form a test image, none of time, color materials and mediums is wasted. Also, even if the user has neither special knowledge nor experience on mediums and the image forming apparatus 1, the user can easily and simply make the image forming apparatus 1 form a proper image.

Note that the present invention is not limited to the above-described embodiment and various changes are possible.

For example, the above embodiment has been described in terms of the case where the physical property measurer 13, etc., are provided inside the image forming apparatus 1 and perform measurement of a medium on a normal medium conveyance path for image forming operation and indicates that measurement of a medium may be performed outside the image forming apparatus 1; however, in this case, the medium type information 172 and a controller for determination of operation settings may also be provided outside the image forming apparatus 1 together, that is, may be formed to be capable of operating as a setting determination apparatus that is completely independent from the image forming apparatus 1.

Also, although the above embodiment has been described in terms of the case where setting candidates are output to and displayed on the display 43 and the operation receiver 42 receives an input operation for selection, it is possible that: information of setting candidates is output to an external device and is displayed on, e.g., a display of the external device; and a setting candidate is selected based on an input signal from the external device.

Also, although the above embodiment has been described in terms of the case where the degree of matching is quantified and setting candidates are displayed in descending order of the degree of matching, initial display does not necessarily need to be displayed in descending order of the degree of matching. Also, irrespective of the order of display, respective values of the degree of matching may be clearly indicated.

Also, the image forming operation section 14 is not limited to one that forms a color image using ink or toner. For example, the image forming operation section 14 may be one capable of outputting a black-and-white image only. Also, although the above embodiment has been described in terms of the case where paper mediums are taken as examples of main mediums and mediums of other materials are handled as exceptional setting mediums, where main mediums are mediums of, e.g., resin or cloth, it is possible to make determination on these mediums normally possible.

Other details including, e.g., the components indicated in the above embodiments and disposition of the components and the content of processing and the procedure of the processing can appropriately be changed without departing from the spirit of the present invention. Although embodiments of the present invention have been described and illustrated in detail, the disclosed embodiments are made for purposes of illustration and example only and not limitation. The scope of the present invention should be interpreted by terms of the appended claims.

What is claimed is:

1. A setting determination apparatus comprising:
a measurer that measures a physical property of a medium; and
a hardware processor,
wherein the hardware processor specifies a basis weight and a type of the medium based on a result of the measurement by the measurer and outputs the specified basis weight and type of the medium as a medium setting candidate for an operation setting for image forming.

2. The setting determination apparatus according to claim 1, wherein the hardware processor categorizes the type of the medium as coated paper or non-coated paper at least.

3. The setting determination apparatus according to claim 1, wherein the hardware processor calculates a degree of matching between (i) the result of the measurement and (ii) a combination of a basis weight and a type of a medium associated with each different operation setting and outputs, of the combination, a combination whose calculated degree of matching meets a predetermined criterion, as the setting candidate.

4. The setting determination apparatus according to claim 3, wherein the hardware processor outputs the combination as the setting candidate in descending order of the degree.

5. The setting determination apparatus according to claim 1, wherein if coated paper and non-coated paper are each output as the setting candidate, the hardware processor performs the output in an order with the coated paper prioritized.

6. The setting determination apparatus according to claim 1, wherein the measurer measures at least two of a surface smoothness, a density, an air permeability, a frictional coefficient, a whiteness, a stiffness and an electric resistance of the medium.

7. The setting determination apparatus according to claim 1, further comprising a display,
wherein the hardware processor outputs the setting candidate to the display and causes the display to display the setting candidate.

8. The setting determination apparatus according to claim 7, further comprising an operation receiver,
wherein the hardware processor receives an input operation of selecting any of the setting candidate displayed by the display, via the operation receiver and makes the operation setting relating to the selected setting candidate.

9. The setting determination apparatus according to claim 1, wherein if the result of the measurement by the measurer meets a predetermined condition, the hardware processor outputs a special type of a medium corresponding to the condition as the setting candidate.

10. The setting determination apparatus according to claim 1, further comprising a storage that stores a brand name of a medium and information on a basis weight and a type of the medium of the brand name in association with each other,
wherein the hardware processor can output, of the brand name, a brand name corresponding to the specified basis weight and type of the medium as the setting candidate.

11. The setting determination apparatus according to claim 10, wherein the hardware processor calculates a degree of matching between (i) the basis weight and the type of the medium specified based on the result of the measurement and (ii) the basis weight and the type of the medium of the brand name as the setting candidate and outputs the brand name in descending order of the degree.

12. The setting determination apparatus according to claim 10, further comprising an operation receiver,
wherein the hardware processor switches the setting candidate to be displayed between (i) a combination of the basis weight and the type of the medium and (ii) the brand name in response to a request received via the operation receiver.

13. The setting determination apparatus according to claim 10, wherein the brand name of the medium and the information on the basis weight and the type of the medium stored in association with each other in the storage are stored as the setting determination apparatus is shipped.

14. The setting determination apparatus according to claim 10, further comprising an operation receiver,
wherein the brand name of the medium and the information on the basis weight and the type of the medium stored in association with each other in the storage are stored according to an input operation by a user using the setting determination apparatus, the input operation being received by the operation receiver.

15. An image forming apparatus comprising:
the setting determination apparatus according to claim 1; and
an image forming operation section that forms an image on the medium.

16. An image forming operation setting method for a setting determination apparatus including a measurer that measures a physical property of a medium, the method comprising:
specifying a basis weight and a type of the medium based on a result of the measurement by the measurer; and
outputting the specified basis weight and type of the medium as a medium setting candidate for an operation setting for image forming.
